(19) United States
(12) Patent Application Publication
(10) Pub. No.: US 2022/0080596 A1
(43) Pub. Date: Mar. 17, 2022

(54) Method Of Presenting Work Time, Method Of Setting Force Control Parameter, Robot System, And Work Time Presentation Program

(71) Applicant: Seiko Epson Corporation, Tokyo (JP)

(72) Inventor: Yasuhiro SHIMODAIRA, Matsumoto (JP)

(21) Appl. No.: 17/472,806

(22) Filed: Sep. 13, 2021

(30) Foreign Application Priority Data
Sep. 14, 2020 (JP) 2020-153568

(51) Int. Cl. B25J 9/16

(52) U.S. Cl. CPC B25J 9/1687; B25J 9/1661; B25J 9/1633

(57) ABSTRACT

A method of presenting a takt time includes a first step of acquiring first information on a type of a first object or a second object and second information on a movement direction of the first object during the work, a second step of acquiring third information on a takt time taken for the work by using a table prepared with respect to each combination of the first information and the second information and showing relationships between a force control parameter and a takt time corresponding to the force control parameter, and associating the first information and the second information acquired at the first step with the table, and a third step of presenting the third information acquired at the second step.

The present application is based on, and claims priority from JP Application Serial Number 2020-153568, filed Sep. 14, 2020, the disclosure of which is hereby incorporated by reference herein in its entirety.

### BACKGROUND

### 1. Technical Field

The present disclosure relates to a method of presenting a takt time, a method of setting a force control parameter, a robot system, and a takt time presentation program.

### 2. Related Art

A robot having a robot arm and a force detection unit that detects a force applied to the robot arm and performing predetermined work by force control to drive the robot arm based on a detection result of the force detection unit is known. In the robot, for example, as disclosed in JP-A-2014-233814, for the force control, it is necessary to set a force control parameter to a suitable value in order to determine a mode in which the robot arm is driven. A takt time taken for work changes depending on the force control parameter.

However, in related art, there is only one method of actually performing the same operation as that of the work and measuring time in order to know the takt time when the work is performed using the set force control parameter. Accordingly, it is necessary to actually drive the robot arm while changing the value of the force control parameter in order to set the force control parameter for obtaining a desired takt time, and the method requires a substantial effort.

### SUMMARY

A method of presenting a takt time according to an aspect of the present disclosure is a method of presenting a takt time in a robot having a robot arm driven by force control of presenting a takt time when the robot arm performs work to grip and insert or pull a first object into or out of a second object, including a first step of acquiring first information on a type of the first object or the second object and second information on a movement direction of the first object during the work, a second step of acquiring third information on a takt time taken for the work by using a table prepared with respect to each combination of the first information and the second information and showing relationships between a force control parameter and a takt time corresponding to the force control parameter, and associating the first information and the second information acquired at the first step with the table, and a third step of presenting the third information acquired at the second step.

A method of setting a force control parameter according to an aspect of the present disclosure is a method of setting a force control parameter in a robot having a robot arm driven by force control of setting a force control parameter by presenting a takt time when the robot arm performs work to grip and insert or pull a first object into or out of a second object, including a first step of acquiring first information on a type of the first object or the second object and second information on a movement direction of the first object during the work, a second step of acquiring third information on a takt time taken for the work by using a table prepared with respect to each combination of the first information and the second information and showing relationships between a force control parameter and a takt time corresponding to the force control parameter, and associating the first information and the second information acquired at the first step with the table, a third step of presenting the third information acquired at the second step, and a fourth step of setting the force control parameter corresponding to the third information as a work force control parameter for the work.

A robot system according to an aspect of the present disclosure includes a robot having a robot arm that performs work to grip and insert or pull a first object into or out of a second object by force control, a presentation unit, and a control unit that controls actuation of the presentation unit, wherein the control unit acquires first information on a type of the first object or the second object and second information on a movement direction of the first object during the work, acquires third information on a takt time taken for the work by using a table prepared with respect to each combination of the first information and the second information and showing relationships between a force control parameter and a takt time corresponding to the force control parameter, and associating the acquired first information and second information with the table, and controls the actuation of the presentation unit to present the acquired third information.

A non-transitory computer-readable storage medium according to an aspect of the present disclosure stores a takt time presentation program for presenting, in a robot having a robot arm driven by force control, a takt time when the robot arm performs work to grip and insert or pull a first object into or out of a second object, for executing a first step of acquiring first information on a type of the first object or the second object and second information on a movement direction of the first object during the work, a second step of acquiring third information on a takt time taken for the work by using a table prepared with respect to each combination of the first information and the second information and showing relationships between a force control parameter and a takt time corresponding to the force control parameter, and associating the first information and the second information acquired at the first step with the table, and a third step of presenting the third information acquired at the second step.

### BRIEF DESCRIPTION OF THE DRAWINGS

FIG. 1 shows an overall configuration of a robot system.

FIG. 2 is a block diagram of the robot system shown in FIG. 1.

FIG. 3 is a plan view showing an example of a display window.

FIG. 4 is a flowchart for explanation of a control operation executed by the robot system shown in FIG. 1.

FIG. 5 is a diagram for explanation of a table.

FIG. 6 is a diagram for explanation of the table.

FIG. 7 is a conceptual diagram for explanation of external rigidity.

FIG. 8 is a block diagram for explanation of the robot system with a focus on hardware.

FIG. 9 is a block diagram showing modified example 1 of the robot system with a focus on hardware.

FIG. 10 is a block diagram showing modified example 2 of the robot system with a focus on hardware.

### DESCRIPTION OF EXEMPLARY EMBODIMENTS

### Embodiment

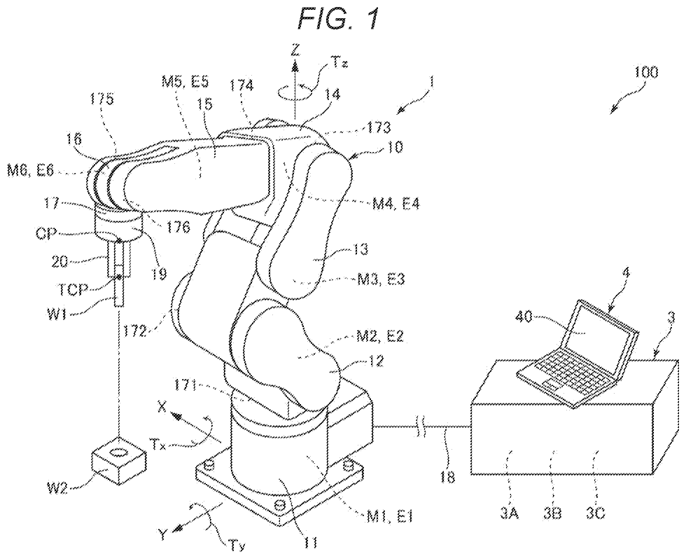

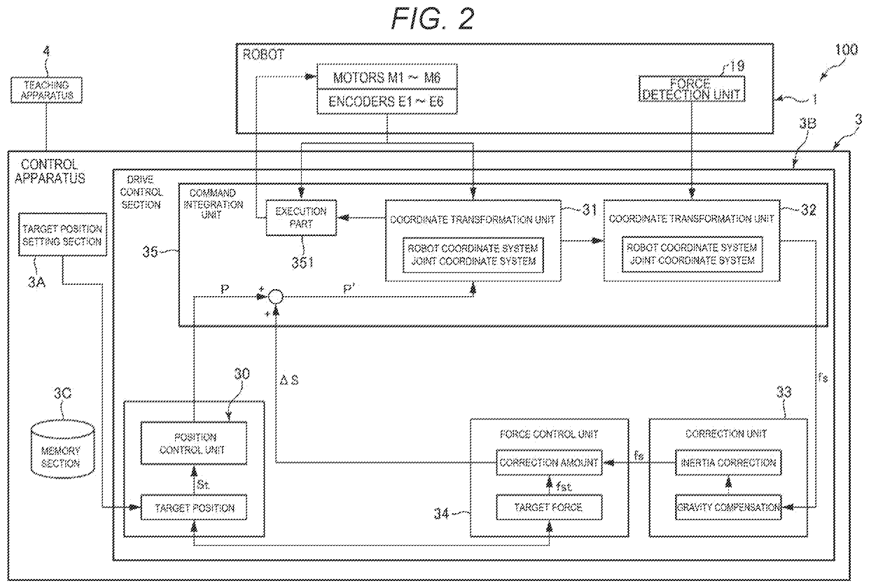

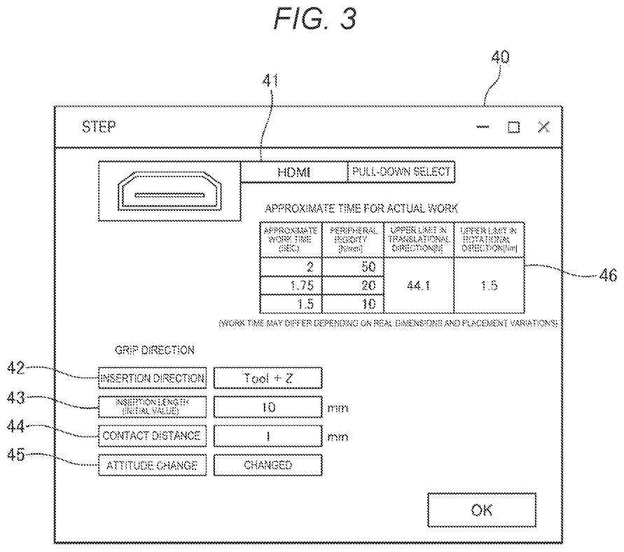

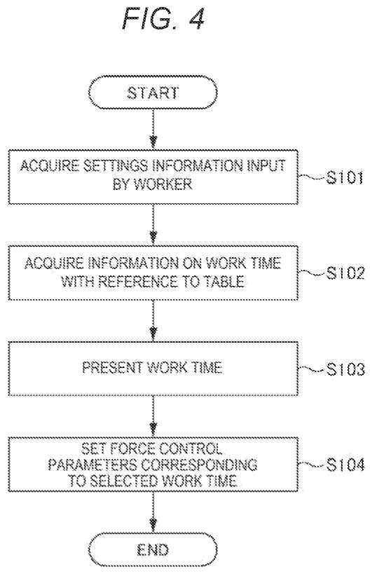

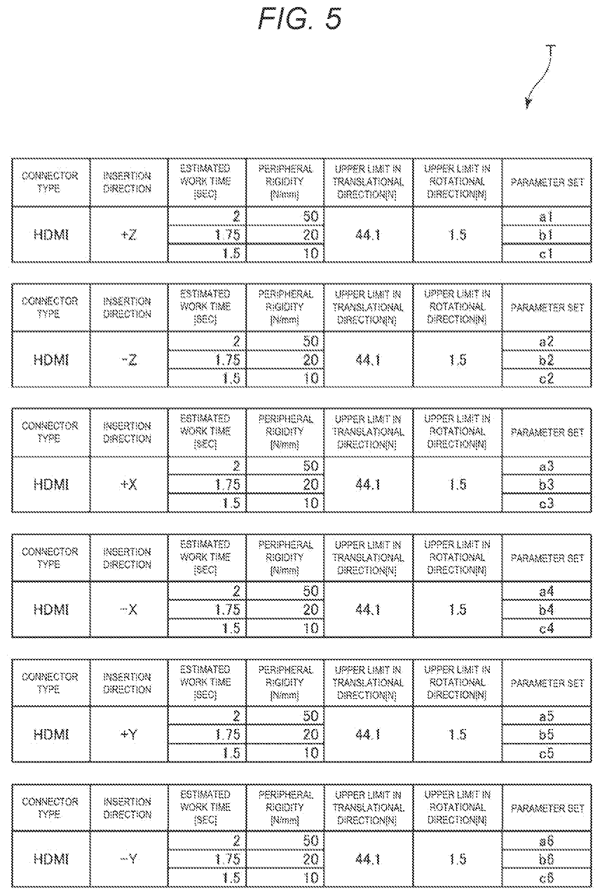

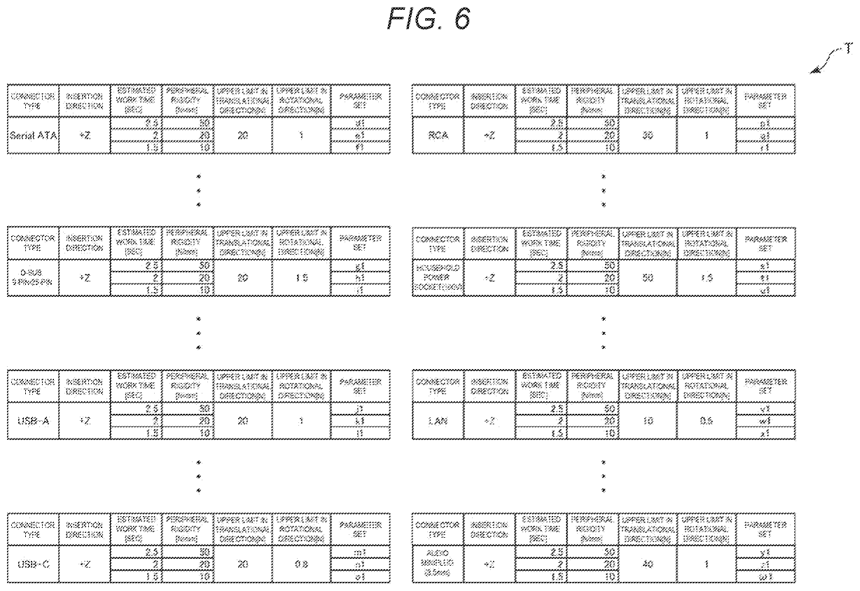

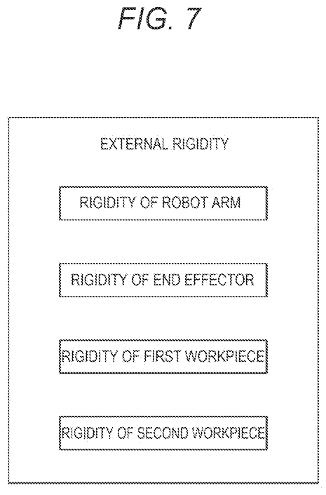

FIG. 1 shows an overall configuration of a robot system. FIG. 2 is a block diagram of the robot system shown in FIG. 1. FIG. 3 is a plan view showing an example of a display window. FIG. 4 is a flowchart for explanation of a control operation executed by the robot system shown in FIG. 1. FIG. 5 is a diagram for explanation of a table. FIG. 6 is a diagram for explanation of the table. FIG. 7 is a conceptual diagram for explanation of external rigidity.

As below, a method of presenting a takt time, a method of setting a force control parameter, a robot system, and a takt time presentation program according to the present disclosure will be explained in detail based on preferred embodiments shown in the accompanying drawings. Hereinafter, for convenience of explanation, a +Z-axis direction, i.e., the upside in FIG. 1 is also referred to as “upper” and a −Z-axis direction, i.e., the downside is also referred to as “lower”. Further, regarding a robot arm, a base 11 side in FIG. 1 is also referred to as “proximal end” and the opposite side, i.e., an end effector side is also referred to as “distal end”. Furthermore, the Z-axis directions, i.e., the upward and downward directions in FIG. 1 are referred to as “vertical directions” and X-axis directions and Y-axis directions, i.e., the leftward and rightward directions are referred to as “horizontal directions”.

As shown in FIG. 1, a robot system 100 includes a robot 1, a control apparatus 3 that controls the robot 1, and a teaching apparatus 4, and executes a method of presenting a takt time according to the present disclosure and a method of setting a force control parameter according to the present disclosure.

First, the robot 1 is explained.

The robot 1 shown in FIG. 1 is a single-arm six-axis vertical articulated robot in the embodiment, and has a base 11 and a robot arm 10. Further, an end effector 20 may be attached to the distal end portion of the robot arm 10. The end effector 20 may be a component element of the robot 1 or not a component element of the robot 1.

Note that the robot 1 is not limited to the illustrated configuration, but may be e.g. a dual-arm articulated robot. Or, the robot 1 may be a horizontal articulated robot.

The base 11 is a supporter that supports the robot arm 10 from the downside so that the robot arm can be driven and fixed to e.g. a floor within a factory. In the robot 1, the base 11 is electrically coupled to the control apparatus 3 via a relay cable 18. Note that the coupling between the robot 1 and the control apparatus 3 is not limited to the wired coupling like the configuration shown in FIG. 1, but may be e.g. wireless coupling or coupling via a network such as the Internet.

In the embodiment, the robot arm 10 has a first arm 12, a second arm 13, a third arm 14, a fourth arm 15, a fifth arm 16, and a sixth arm 17, and these arms are sequentially coupled from the base 11 side. Note that the number of the arms of the robot arm 10 is not limited to six, but may be e.g. one, two, three, four, five, seven, or more. The sizes including the entire lengths of the respective arms are not particularly limited, but can be appropriately set.

The base 11 and the first arm 12 are coupled via a joint 171. Further, the first arm 12 is pivotable about a first pivot axis parallel to the vertical directions as a pivot center relative to the base 11. The first pivot axis is aligned with a normal of the floor to which the base 11 is fixed.

The first arm 12 and the second arm 13 are coupled via a joint 172. Further, the second arm 13 is pivotable about a second pivot axis parallel to the horizontal directions as a pivot center relative to the first arm 12. The second pivot axis is parallel to an axis orthogonal to the first pivot axis.

The second arm 13 and the third arm 14 are coupled via a joint 173. Further, the third arm 14 is pivotable about a third pivot axis parallel to the horizontal directions as a pivot center relative to the second arm 13. The third pivot axis is parallel to the second pivot axis.

The third arm 14 and the fourth arm 15 are coupled via a joint 174. Further, the fourth arm 15 is pivotable about a fourth pivot axis parallel to the center axis direction of the third arm 14 as a pivot center relative to the third arm 14. The fourth pivot axis is orthogonal to the third pivot axis.

The fourth arm 15 and the fifth arm 16 are coupled via a joint 175. Further, the fifth arm 16 is pivotable about a fifth pivot axis as a pivot center relative to the fourth arm 15. The fifth pivot axis is orthogonal to the fourth pivot axis.

The fifth arm 16 and the sixth arm 17 are coupled via a joint 176. Further, the sixth arm 17 is pivotable about a sixth pivot axis as a pivot center relative to the fifth arm 16. The sixth pivot axis is orthogonal to the fifth pivot axis.

Furthermore, the sixth arm 17 is a robot distal end portion located at the most distal end side of the robot arm 10. The sixth arm 17 may pivot together with the end effector 20 by driving of the robot arm 10.

The robot 1 includes a motor M1, a motor M2, a motor M3, a motor M4, a motor M5, and a motor M6 as drive units and an encoder E1, an encoder E2, an encoder E3, an encoder E4, an encoder E5, and an encoder E6. The motor M1 is provided inside of the joint 171 and relatively rotates the base 11 and the first arm 12. The motor M2 is provided inside of the joint 172 and relatively rotates the first arm 12 and the second arm 13. The motor M3 is provided inside of the joint 173 and relatively rotates the second arm 13 and the third arm 14. The motor M4 is provided inside of the joint 174 and relatively rotates the third arm 14 and the fourth arm 15. The motor M5 is provided inside of the joint 175 and relatively rotates the fourth arm 15 and the fifth arm 16. The motor M6 is provided inside of the joint 176 and relatively rotates the fifth arm 16 and the sixth arm 17.

Further, the encoder E1 is provided inside of the joint 171 and detects the position of the motor M1. The encoder E2 is provided inside of the joint 172 and detects the position of the motor M2. The encoder E3 is provided inside of the joint 173 and detects the position of the motor M3. The encoder E4 is provided inside of the joint 174 and detects the position of the motor M4. The encoder E5 is provided inside of the joint 175 and detects the position of the motor M5. The encoder E6 is provided inside of the joint 176 and detects the position of the motor M6.

The encoder E1 to encoder E6 are electrically coupled to the control apparatus 3 and position information, i.e., amounts of rotation of the motor M1 to motor M6 are transmitted to the control apparatus 3 as electrical signals. Then, the control apparatus 3 drives the motor M1 to motor M6 via motor drivers (not shown) based on the information. That is, to control the robot arm 10 is to control the motor M1 to motor M6.

A control point CP is set at the distal end of the robot arm 10. The control point CP is a point as a reference for control of the robot arm 10. In the robot system 100, the position of the control point CP is acquired in a robot coordinate system and the robot arm 10 is driven to move the control point CP to a desired position.

Further, in the robot 1, a force detection unit 19 that detects a force is detachably placed in the robot arm 10. The robot arm 10 may be driven with the force detection unit 19 placed therein. The force detection unit 19 is a six-axis force sensor in the embodiment. The force detection unit 19 detects magnitude of forces on three detection axes orthogonal to one another and magnitude of torque about the three detection axes. That is, the force detection unit 19 detects force components in the respective axial directions of the X-axis, the Y-axis, Z-axis orthogonal to one another, a force component in a Tx direction about the X-axis, a force component in a Ty direction about the Y-axis, and a force component in a Tz direction about the Z-axis. Note that, in the embodiment, the Z-axis directions are the vertical directions. The force components in the respective axial directions may be referred to as “translational force components” and the force components about the respective axes may be referred to as “torque components”. The force detection unit 19 is not limited to the six-axis force sensor, but may have another configuration.

In the embodiment, the force detection unit 19 is placed in the sixth arm 17. Note that the placement position of the force detection unit 19 is not limited to the sixth arm 17, i.e., the arm located at the most distal end side, but may be in the other arm, between the adjacent arms, or in a lower part of the base 11, for example.

The end effector 20 may be detachably attached to the force detection unit 19. The end effector 20 includes a hand gripping an object by moving a pair of claws closer to or away from each other. The present disclosure is not limited to that, but two or more claws may be provided. Or, a hand gripping an object by adsorption may be employed.

Further, in the robot coordinate system, a tool center point TCP is set in an arbitrary position at the distal end of the end effector 20, preferably, at the distal end at which the respective claws are close to each other. As described above, in the robot system 100, the position of the control point CP is acquired in the robot coordinate system and the robot arm 10 is driven to move the control point CP to a desired position. The type, particularly, the length of the end effector 20 is acquired, and thereby, an offset amount between the tool center point TCP and the control point CP may be acquired. Accordingly, the position of the tool center point TCP may be acquired in the robot coordinate system. Therefore, the tool center point TCP may be used as a reference for the control.

As shown in FIG. 1, the robot 1 performs work to grip, insert, and fits a workpiece W1 as a first object into a workpiece W2 as a second object. Here, “fit” is used as not only “fit” in the narrow sense, but used in the broad sense including “fit in” and “engage”. Therefore, depending on the configurations of the workpiece W1 and the workpiece W2, “fit” may be read to “fit in”, “engage”, or the like. Note that the work may be work to grip the workpiece W2 and insert the workpiece W1 into the workpiece W2.

The workpiece W1 is a rod-shape member having a circular cross-sectional shape. Note that the workpiece W1 may have a cross-sectional shape in a polygonal shape such as a triangular shape, a quadrangular shape, or a shape with more vertices, or a star shape. The workpiece W2 has a block shape having an insertion hole in which the workpiece W1 is inserted.

Next, the control apparatus 3 and the teaching apparatus 4 will be explained.

The control apparatus 3 is placed apart from the robot 1 and includes a computer having a CPU (Central Processing Unit) as an example of a processor provided therein. The control apparatus 3 may be provided inside of the base 11 of the robot 1.

The control apparatus 3 is communicably coupled to the robot 1 by the relay cable 18. The control apparatus is coupled to the teaching apparatus 4 by a cable or communicably coupled in wireless connection. The teaching apparatus 4 may be a dedicated computer or a general-purpose computer in which programs for teaching the robot 1 are installed. For example, a teaching pendant or the like as a dedicated device for teaching the robot 1 may be used in place of the teaching apparatus 4. Or, the control apparatus 3 and the teaching apparatus 4 may have separate housings or may be integrally formed.

In the teaching apparatus 4, a program for generating an execution program having a target position and attitude Sₜ and a target force f_{St}, which will be described later, as parameters in the control apparatus 3 and loading the execution program in the control apparatus 3 may be installed. The teaching apparatus 4 includes a display, a processor, a RAM, and a ROM, and these hardware resources generate the execution program in cooperation with a teaching program.

As shown in FIG. 2, the control apparatus 3 is a computer in which a control program for control of the robot is installed. The control apparatus 3 includes a processor and a RAM and a ROM (not shown), and these hardware resources control the robot 1 in cooperation with the program.

Further, as shown in FIG. 2, the control apparatus 3 has a target position setting section 3A, a drive control section 3B, and a memory section 3C. The memory section 3C includes e.g. a volatile memory such as a RAM (Random Access Memory), a nonvolatile memory such as a ROM (Read Only Memory), and a detachable external memory device. In the memory section 3C, operation programs for actuation of the robot 1 including programs for execution of the method of presenting the takt time and the method of setting the force control parameter according to the present disclosure are stored.

The target position setting section 3A sets the target position and attitude Sₜ and a motion route for execution of predetermined work on the workpiece W1. The target position setting section 3A sets the target position and attitude Sₜ and the motion route based on teaching information input from the teaching apparatus 4 or the like.

The drive control section 3B controls driving of the robot arm 10 and has a position control unit 30, a coordinate transformation unit 31, a coordinate transformation unit 32, a correction unit 33, a force control unit 34, and a command integration unit 35.

The position control unit 30 generates a position command signal, i.e., a position command value for controlling the position of the tool center point TCP of the robot 1 according to a target position designated by a command created in advance.

Here, the control apparatus 3 can control motion of the robot 1 by force control or the like. “Force control” refers to control of the motion of the robot 1 to change the position of the end effector 20, i.e., the position of the tool center point TCP and the attitudes of the first arm 12 to sixth arm 17 based on the detection result of the force detection unit 19.

The force control includes e.g. force trigger control and impedance control. In the force trigger control, force detection is performed by the force detection unit 19, and the robot arm 10 is moved and changed in attitude until a predetermined force is detected by the force detection unit 19.

The impedance control includes profile control. First, in brief explanation, in the impedance control, the motion of the robot arm 10 is controlled so that the force applied to the distal end portion of the robot arm 10 may be maintained as equal to the predetermined force as possible, that is, a force in a predetermined direction detected by the force detection unit 19 may be maintained as equal to the target force f_{St} as possible. Thereby, for example, when the impedance control is performed on the robot arm 10, the robot arm 10 performs profiling motion for an external force applied by an object or an operator with respect to the predetermined direction. Note that the target force f_{St} includes zero. For example, in a case of the profiling motion, the target value may be set to “0”. The target force f_{St} may be set to another numerical value than zero. The target force f_{St} can be appropriately set by the worker.

The memory section 3C stores correspondence relationships between combinations of the rotation angles of the motor M1 to motor M6 and the positions of the tool center point TCP in the robot coordinate system. Further, the control apparatus 3 stores at least one of the target position and attitude Sₜ and the target force f_{St} for each step of the work performed by the robot 1 according to the command in the memory section 3C. The command having the target position and attitude Sₜ and the target force f_{St} as parameters is set for each step of the work performed by the robot 1.

The drive control section 3B controls the first arm 12 to sixth arm 17 so that the set target position and attitude Sₜ and target force f_{St} may coincide at the tool center point TCP. The target force f_{St} is a detection force and torque of the force detection unit 19 to be achieved by the motion of the first arm 12 to sixth arm 17. Here, the character “S” expresses one direction of directions of the axes (X, Y, Z) defining the robot coordinate system. Further, “S” also expresses a position in an S direction. For example, when S=X, an X direction component of the target position set in the robot coordinate system is Sₜ=Xₜ, and an X direction component of the target force is f_{St}=f_{Xt}.

In the drive control section 3B, when the rotation angles of the motor M1 to motor M6 are acquired, the coordinate transformation unit 31 shown in FIG. 2 transforms the rotation angles into the position and attitude S (X, Y, Z, Tx, Ty, Tz) of the tool center point TCP in the robot coordinate system based on the correspondence relationships. Then, the coordinate transformation unit 32 specifies an acting force fs actually acting on the force detection unit 19 in the robot coordinate system based on the position and attitude S of the tool center point TCP and the detection value of the force detection unit 19.

The point of application of the acting force fs is defined as a force detection origin separate from the tool center point TCP. The force detection origin corresponds to a point at which the force detection unit 19 detects a force. Note that the control apparatus 3 stores a correspondence relationship defining directions of detection axes in a sensor coordinate system of the force detection unit 19 with respect to each position and attitude S of the tool center point TCP in the robot coordinate system. Therefore, the control apparatus 3 may specify the acting force fs in the robot coordinate system based on the position and attitude S of the tool center point TCP in the robot coordinate system and the correspondence relationship. Further, torque acting on the robot may be calculated from the acting force fs and a distance from a contact point to the force detection unit 19 and is specified as a torque component. Note that, when the end effector 20 performs work in contact with the workpiece W1, the contact point may be regarded as the tool center point TCP.

The correction unit 33 performs gravity compensation on the acting force fs. The gravity compensation refers to removal of components of a force and torque caused by the gravity force from the acting force fs. The gravity-compensated acting force fs may be regarded as another force than the gravity force acting on the robot arm 10 or the end effector 20.

Further, the correction unit 33 performs inertia compensation on the acting force f_{S}. The inertia compensation refers to removal of components of a force and torque caused by the inertial force from the acting force fs. The inertia-compensated acting force f_{S} may be regarded as another force than the inertial force acting on the robot arm 10 or the end effector 20.

The force control unit 34 performs impedance control. The impedance control is active impedance control that realizes virtual mechanical impedance using the motor M1 to motor M6. The control apparatus 3 executes the impedance control in processes under contact conditions in which forces are applied to the end effector 20 from workpieces as objects including fitting work, screwing work, polishing work of the workpieces and for direct teaching. Even in another case than the above described processes, for example, the impedance control is performed when a human contacts the robot 1, and thereby, safety may be increased.

In the impedance control, the target force f_{St} is substituted into the equation of motion, which will be described later, and the rotation angles of the motor M1 to motor M6 are derived. The signals for controlling the motor M1 to motor M6 by the control apparatus 3 are PWM (Pulse Width Modulation)-modulated signals.

In a non-contact process in which no external force is applied to the end effector 20, the control apparatus 3 controls the motor M1 to motor M6 at the rotation angles derived by linear calculation from the target position and attitudes Sₜ. A mode in which the motor M1 to motor M6 are controlled at the rotation angles derived by linear calculation from the target position and attitudes Sₜ is referred to as “position control mode”.

The control apparatus 3 specifies a force-derived correction amount ΔS by substitution of the target force f_{St} and the acting force f_{S} into the equation of motion of the impedance control. The force-derived correction amount ΔS refers to magnitude of the position and attitude S to which the tool center point TCP should move to resolve a force deviation Δf_{S}(t) from the target force f_{St} when the tool center point TCP is subjected to mechanical impedance. The following Equation (1) is the equation of motion of the impedance control.

mΔ\ddot{S}(t)+dΔ\dot{S}(t)+kΔS(t)=Δf_{S}(t) (1)

The left side of Equation (1) is formed by the first term in which the second-order differential value of the position and attitude S of the tool center point TCP is multiplied by a virtual mass coefficient m (hereinafter, referred to as “mass coefficient m”), the second term in which the differential value of the position and attitude S of the tool center point TCP is multiplied by a virtual viscosity coefficient d (hereinafter, referred to as “viscosity coefficient d”), and the third term in which the position and attitude S of the tool center point TCP is multiplied by a virtual elastic coefficient k (hereinafter, referred to as “elastic coefficient k”). The right side of Equation (1) is formed by the force deviation Δf_{S}(t) obtained by subtraction of the real force f from the target force f_{St}. The differential in Equation (1) refers to time differential. In a process performed by the robot 1, a constant value may be set as the target force f_{St} or a time function may be set as the target force f_{St}.

The mass coefficient m refers to a mass that the tool center point TCP virtually has, the viscosity coefficient d refers to a viscous resistance to which the tool center point TCP is virtually subjected, and the elastic coefficient k refers to a spring constant of an elastic force to which the tool center point TCP is virtually subjected.

The larger the value of the mass coefficient m, the lower the acceleration of the motion, and the smaller the value of the mass coefficient m, the higher the acceleration of the motion. The larger the value of the viscosity coefficient d, the lower the velocity of the motion, and the smaller the value of the viscosity coefficient d, the higher the velocity of the motion. The larger the value of the elastic coefficient k, the higher the spring property, and the smaller the value of the elastic coefficient k, the lower the spring property.

In this specification, the respective mass coefficient m, viscosity coefficient d, and elastic coefficient k are referred to as “force control parameters”. These mass coefficient m, viscosity coefficient d, and elastic coefficient k may be set to different values with respect to each direction or set to common values regardless of the directions. Further, the mass coefficient m, the viscosity coefficient d, and the elastic coefficient k can be appropriately set by the worker before work. This will be described later in detail.

As described above, in the robot system 100, the correction amount is obtained from the detection value of the force detection unit 19, the preset force control parameters, and the preset target force. The correction amount refers to the above described force-derived correction amount ΔS and a difference between the position in which the external force is applied and the position to which the tool center point TCP should be moved.

Then, the command integration unit 35 adds the force-derived correction amount ΔS to the position command value P generated by the position control unit 30. The addition is performed as necessary, and thereby, the command integration unit 35 obtains a new position command value P′ from the position command value P used for movement to the position in which the external force is applied.

Then, the coordinate transformation unit 31 transforms the new position command value P′ into the robot coordinates and an execution part 351 executes, and thereby, the tool center point TCP is moved to the position in consideration of the force-derived correction amount ΔS and the impact by the application of the external force may be relaxed and the more load applied to the object in contact with the robot 1 may be relaxed.

According to the above described drive control section 3B, the robot arm 10 may be driven with the workpiece W1 gripped to move the tool center point TCP toward the target position and attitude Sₜ and to move the tool center point TCP until the target force f_{St} becomes a preset value. Specifically, the insertion work is performed until the workpiece W1 is inserted into the insertion hole of the workpiece W2 and the preset target force f_{St} is detected, and thereby, the insertion work may be completed. Further, in the insertion process, the above described force control is performed, and thereby, excessive loads applied to the workpiece W1 and the workpiece W2 may be prevented or suppressed.

Here, it is necessary for the worker to set the above described force control parameters, i.e., the above described mass coefficient m, viscosity coefficient d, and elastic coefficient k to appropriate values before work according to details of the work, types of the workpiece W1 and the workpiece W2, or the like. These coefficients are set to the appropriate values, and thereby, the mode of the robot arm 10 during work may be set in a mode suitable for the work and accurate and prompt work may be performed.

Further, a takt time changes depending on the set force control parameters. Accordingly, for setting the force control parameters, the worker may use the takt time as a guide for setting of the force control parameters by knowing the takt time when work is performed with the force control parameters. However, to know the takt time, in related art, desirable force control parameters are searched for by repeating work to control the robot to actually perform work and measure the takt time with the current force control parameters and, if the desirable takt time is not obtained, changing the force control parameters. This work requires a substantial effort and takes time. Accordingly, in the present disclosure, the problems of related art are solved in the following manner. As below, the solution will be explained according to the flowchart shown in FIG. 4.

As below, an example of the method of setting the force control parameters according to the present disclosure will be explained using the flowchart shown in FIG. 4. The following respective steps S101 to S104 are shared by the control apparatus 3 and the teaching apparatus 4 in the embodiment, however, the present disclosure is not limited to that. One of the control apparatus 3 and the teaching apparatus 4 may execute the steps.

“Acquisition” in this specification refers to reception and storage of information in one of the control apparatus 3, the teaching apparatus 4, and a communicable external memory device.

### 1. Step S101

Step S101 is a step at which the worker inputs using a display window 40 shown in FIG. 3 and the processor of the teaching apparatus 4 executes based on the input. First, the display window 40 is explained. The display window 40 is displayed on the display of the teaching apparatus 4 and the worker may perform various settings by operating the window. Note that the display window 40 may be displayed on another display than that of the teaching apparatus 4.

The display window 40 has a first input portion 41, a second input portion 42, a third input portion 43, a fourth input portion 44, and a fifth input portion 45.

First information on the types of the workpiece W1 and the workpiece W2 is input by the first input portion 41. In the illustrated configuration, by pull-down select, i.e., selection of the first input portion 41, a list of the types of the workpiece W1 and the workpiece W2 is displayed and the types are selected from the list. FIG. 3 shows an example of selection of HDMI.

Second information on an insertion direction is input by the second input portion 42. The insertion direction refers to a movement direction of the workpiece W1 when the workpiece W1 is inserted into the workpiece W2. By pull-down select, i.e., selection of the second input portion 42, a list of the insertion directions is displayed and the direction is selected from the list in the second input portion 42. Characters of “Tool+X”, “Tool−X”, “Tool+Y”, “Tool−Y”, “Tool+Z”, “Tool−Z”, etc. (not shown) are displayed therein. FIG. 3 shows an example of selection of “Tool+Z”, i.e., an insertion direction from the +Z-axis side toward the −Z-axis side.

Third information on an insertion length of the workpiece W1 inserted into the insertion hole of the workpiece W2 is input by the third input portion 43. The third input portion 43 has a configuration to which a numerical value is directly input. FIG. 3 shows an example of input of the insertion length of 10 mm.

Fourth information on a distance from an initial position at the start of work to a position where the workpiece W1 and the workpiece W2 contact is input by the fourth input portion 44. The fourth input portion 44 has a configuration to which a numerical value is directly input. FIG. 3 shows an example of input of the contact distance 1 mm.

Fifth information on whether or not the attitude of the workpiece W1 is changed when the workpiece W1 is inserted is input by the fifth input portion 45. FIG. 3 shows an example of the attitude changed.

The first input portion 41 to fifth input portion may have e.g. configurations in which cursors are operated and selected using a mouse, a keyboard, or the like or touch-panel configurations in which the worker touches desirable positions to select and input.

The worker performs the above described settings by operating the first input portion 41 to fifth input portion 45, and thereby, the teaching apparatus 4 acquires the setting information. Note that the case where the first information to fifth information are input is explained as above, however, the present disclosure is not limited to that. By input of at least the first information and the second information, the takt time may be acquired at the second step, which will be described later. That is, the third input portion 43 to fifth input portion 45 may be omitted.

The above described step S101 is a first step of acquiring the first information on the type of the workpiece W1 as the first object or the workpiece W2 as the second object and the second information on the movement direction of the workpiece W1 during work.

### 2. Step S102

Then, at step S102, information on the takt time is acquired with reference to a table T shown in FIGS. 5 and 6. That is, the information acquired at step S101 is associated with the table T and the third information on the takt time is acquired.

The table T is prepared with respect to each input information at step S101 and shows relationships between the force control parameters and the takt times corresponding to the force control parameters. The table T is stored with respect to each type of the workpiece W1 or the workpiece W2 and the insertion direction.

As shown in FIG. 5, in the table T, the type of the workpiece W1 and the workpiece W2 is “HDMI” and three of the takt times and the values of the force control parameters, i.e., parameter sets are stored with respect to each insertion direction of “+Z”, “−Z”, “+X”, “−X”, “+Y”, and “−Y”.

Specifically, in a combination of the type “HDMI” and the insertion direction “+Z”, three parameter sets a1, b1, c1 are stored. Further, the takt time “2 seconds” when work is performed with the parameter set “a1” is associated with “a1” and stored. Similarly, the takt time “1.75 seconds” when work is performed with the parameter set “b1” is associated with “b1” and stored, and the takt time “1.5 seconds” when work is performed with the parameter set “c1” is associated with “c1” and stored. Further, the takt time is a value experimentally obtained in advance.

Note that the parameter sets a1, b1, c1 are combinations of actual values of the mass coefficient m, the viscosity coefficient d, and the elastic coefficient k. These parameter sets are recommended values set according to the types of the workpiece W1 and the workpiece W2 and the insertion directions. This applies to a2 to a6, b2 to b6, c2 to c6, d1 to w1, which will be described later.

As shown in FIG. 6, the above described data set is stored with respect to each type of the workpiece W1 and the workpiece W2, e.g. “Serial ATA”, “D-SUB”, “USB-A”, “USB-C”, “RCA”, “household power socket”, “LAN”, and “audio miniplug”.

Note that FIG. 6 representatively shows only the data of the insertion direction “+Z”, however, actually, three of the takt times and the parameter sets are stored with respect to each insertion direction of “−Z”, “+X”, “−X”, “+Y”, and “−Y” like those in FIG. 5.

The case where three of the takt times and the parameter sets are stored with respect to each type and direction is explained, however, the present disclosure is not limited to that. One, two, four, or more thereof may be stored.

The above described table T may be stored in a memory of at least one of the control apparatus 3 and the teaching apparatus 4 or stored in an external server that can communicate with the robot system 100 or the like.

At step S102, a plurality of, three in the embodiment, pieces of information of the pairs of the takt time and the parameter set are obtained with reference to the table T according to the information input at step S101. The step S102 is a second step of acquiring the third information on the takt time taken for work by using the table prepared with respect to each combination of the first information and the second information and showing the relationships between the force control parameter and the takt time corresponding to the force control parameter and associating the first information and the second information acquired at the first step with the table.

Further, at step S102, information of “external rigidity”, “upper limit in translational direction”, and “upper limit in rotational direction” is acquired in addition to the takt time and the parameter set. As shown in FIGS. 5 and 6, in the table T, “external rigidity”, “upper limit in translational direction”, and “upper limit in rotational direction” are stored in correspondence with the takt time and the parameter set.

The external rigidity refers to rigidity of the entire external part as seen from the tool center point TCP. That is, as shown in FIG. 7, the external rigidity refers to entire rigidity in consideration of rigidity of the robot arm 10, rigidity of the end effector 20, rigidity of the workpiece W1, and rigidity of the workpiece W2. The rigidity of each element correlates with an external force applied to the robot arm 10. In other words, the external rigidity is determined by a function of an amount of movement of the tool center point TCP and the external force applied to the robot arm 10, i.e., an external force obtained from the detection value detected by the force detection unit 19. Further, the external rigidity is a real number expressed in a unit of “N/mm” or “Nmm/deg”.

Note that the external rigidity includes rigidity of a workbench (not shown) on which the workpiece W2 is mounted, rigidity of a placement surface on which the robot 1 is placed, etc. in addition to the above described rigidity.

“Upper limit in translational direction” refers to an upper limit of an external force applied to the robot arm 10, i.e., a reaction force received from the workpiece W2 when the workpiece W1 is moved in a direction along one axis of the X-axis, the Y-axis, and the Z-axis during execution of force control. In the embodiment, the upper limit is set to the same value independent of the values of the takt time and the parameter set.

“Upper limit in rotational direction” refers to an upper limit of an external force applied to the robot arm 10, i.e., a reaction force received from the workpiece W2 when the workpiece W1 is rotated in a direction about one axis of the X-axis, the Y-axis, and the Z-axis during execution of force control. In the embodiment, the upper limit is set to the same value independent of the values of the takt time and the parameter set.

3. Step S103

Then, at step S103, the takt time is presented. At this step, as shown in FIG. 3, a takt time display portion 46 is displayed in the display window 40. The takt time display portion 46 displays “approximate takt time”, “external rigidity”, “upper limit in translational direction”, and “upper limit in rotational direction”.

“Approximate takt time” corresponds to “estimated takt time” shown in FIGS. 5 and 6. As shown in FIG. 3, when “HDMI” and “+Z” are input, data in the upper part of the table T in FIG. 5 is displayed. That is, three takt times “2”, “1.75”, and “1.5” are displayed.

The external rigidity, the upper limit in translational direction, and the upper limit in rotational direction corresponding to the takt time of 2 seconds are displayed as “50”, “44.1”, and “1.5” on the right of “2”. Further, the external rigidity, the upper limit in translational direction, and the upper limit in rotational direction corresponding to the takt time of 1.75 seconds are displayed as “20”, “44.1”, and “1.5” on the right of “1.75”. Furthermore, the external rigidity, the upper limit in translational direction, and the upper limit in rotational direction corresponding to the takt time of 1.5 seconds are displayed as “10”, “44.1”, and “1.5” on the right of “1.5”.

The above described step S103 is a third step of presenting the third information acquired at step S102 as the second step. Note that, in the embodiment, the information acquired at step S102 is displayed in the display window 40 and presented, however, the present disclosure is not limited to that configuration. The information may be displayed on another display than the display window 40 or presented by sound.

4. Step S104

Then, when the worker selects the displayed takt time in the display window 40, the force control parameters corresponding to the selected takt time are set as force control parameters during the work. For example, in FIG. 3, when the takt time “2” is selected, a1 as the parameter set corresponding to the takt time “2” is set as the force control parameters during the work from the table shown in FIG. 5. Therefore, a desirable takt time is selected, and thereby, the force control parameters corresponding to the takt time may be easily set.

The above described step S104 is a fourth step of setting the force control parameters corresponding to the third information as the work force control parameters for the work.

As described above, the method of presenting the takt time according to the present disclosure is the method of presenting the takt time in the robot 1 having the robot arm 10 driven by the force control of presenting the takt time when the robot arm 10 performs work to grip and insert or pull the workpiece W1 as the first object into or out of the workpiece W2 as the second object. Further, the method of presenting the takt time according to the present disclosure has the first step of acquiring the first information on the type of the workpiece W1 or the workpiece W2 and the second information on the movement direction of the workpiece W1 during the work, the second step of acquiring the third information on the takt time taken for the work by using the table T prepared with respect to each combination of the first information and the second information and showing relationships between the force control parameters and the takt times corresponding to the force control parameters, and associating the first information and the second information acquired at the first step with the table T, and the third step of presenting the third information acquired at the second step. Thereby, the worker may immediately know the takt time. Therefore, setting of the force control parameters may be easily and promptly performed.

The robot system 100 according to the present disclosure includes the robot 1 having the robot arm 10 that performs work to grip and insert or pull the workpiece W1 as the first object into or out of the workpiece W2 as the second object by the force control, the display window 40 as a presentation unit, and the processor of the teaching apparatus 4 as a control unit that controls the actuation of the display window 40. Further, the processor of the teaching apparatus 4 acquires the first information on the type of the workpiece W1 or the workpiece W2 and the second information on the movement direction of the workpiece W1 during the work, acquires the third information on the takt time taken for work by using the table T prepared with respect to each combination of the first information and the second information and showing relationships between the force control parameters and the takt times corresponding to the force control parameters and associating the acquired first information and second information with the table T, and controls the actuation of the display window 40 to present the acquired third information. Thereby, the worker may immediately know the takt time. Therefore, setting of the force control parameters may be easily and promptly performed.

Furthermore, the takt time presentation program according to the present disclosure is the takt time presentation program, in the robot 1 having the robot arm 10 driven by the force control, for presenting the takt time when the robot arm 10 performs work to grip and insert or pull the workpiece W1 as the first object into or out of the workpiece W2 as the second object. Further, the takt time presentation program according to the present disclosure is for executing the first step of acquiring the first information on the type of the workpiece W1 or the workpiece W2 and the second information on the movement direction of the workpiece W1 during the work, the second step of acquiring the third information on the takt time taken for the work by using the table T prepared with respect to each combination of the first information and the second information and showing relationships between the force control parameters and the takt times corresponding to the force control parameters and associating the first information and the second information acquired at the first step with the table T, and the third step of presenting the third information acquired at the second step. The program is executed, and thereby, the worker may immediately know the takt time. Therefore, setting of the force control parameters may be easily and promptly performed.

Note that the takt time presentation program according to the present disclosure may be stored in a memory unit of the control apparatus 3 or the teaching apparatus 4, stored in a recording medium e.g. a CD-ROM or the like, or stored in a memory device that can be connected via a network or the like.

At step S102 as the second step, for one combination of the type of the workpiece W1 or the workpiece W2 as the first information and the information of the insertion direction of the workpiece W1 as the second information, information of the takt time as a plurality of pieces of the third information corresponding to the plurality of different force control parameters are acquired, and, at the third step, the information of the plurality of takt times is presented. Thereby, the worker may know a plurality of candidates of the takt time with respect to each of the plurality of force control parameters. Therefore, setting of the force control parameters may be performed more accurately.

At step S103 as the third step, the upper limit of the external force applied to the robot arm 10 during the work is presented according to the first information and the second information input at step S101 as the first step. Thereby, when setting the upper limit of the external force applied to the robot arm 10 during the work, the worker may accurately perform the setting.

At the first step, at least one piece of information on an insertion distance of the workpiece W1 as the first object, a movement distance of the workpiece W1 from the work start position to the contact position in which the workpiece W1 and the workpiece W2 as the second object contact, and whether or not the attitude of the workpiece W1 is changed during the work is further acquired. The takt times in consideration of the information are stored in the table T, and thereby, more accurate setting of the force control parameters may be performed.

The method of setting the force control parameters according to the present disclosure is the method of setting the force control parameters of setting the force control parameters in the robot 1 having the robot arm 10 driven by the force control by presenting the takt time when the robot arm 10 performs work to grip and insert or pull the workpiece W1 as the first object into or out of the workpiece W2 as the second object. Further, the method of setting the force control parameters according to the present disclosure has the first step of acquiring the first information on the type of the workpiece W1 or the workpiece W2 and the second information on the movement direction of the workpiece W1 during the work, the second step of acquiring the third information on the takt time taken for work by using the table T prepared with respect to each combination of the first information and the second information and showing relationships between the force control parameters and the takt times corresponding to the force control parameters, and associating the first information and the second information acquired at the first step with the table T, the third step of presenting the third information acquired at the second step, and the fourth step of setting the force control parameters corresponding to the third information as work force control parameters for the work. The program is executed, and thereby, the worker may immediately know the takt time. Therefore, setting of the force control parameters may be easily and promptly performed.

At step S104 as the fourth step, the force control parameters corresponding to the information on the takt time as the selected third information are set as work force control parameters for the work. Thereby, work to input actual numbers of the force control parameters by the worker may be omitted and setting of the force control parameters may be performed more easily.

### Other Configuration Examples of Robot System

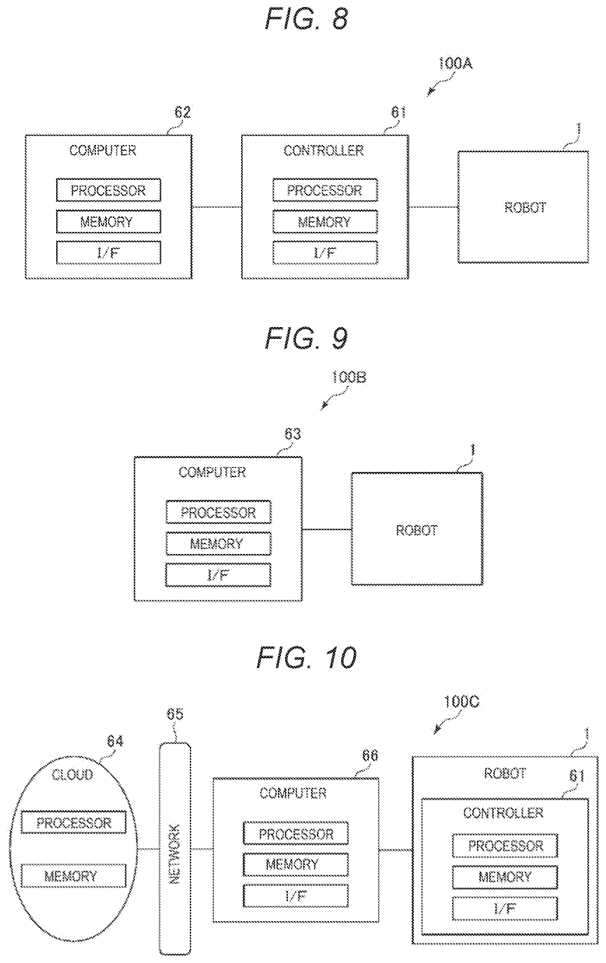

FIG. 8 is a block diagram for explanation of the robot system with a focus on hardware.

FIG. 8 shows an overall configuration of a robot system 100A in which the robot 1, a controller 61, and a computer 62 are coupled. The control of the robot 1 may be executed by reading of a command in a memory using a processor in the controller 61 or executed by reading of a command in a memory using a processor in the computer 62 via the controller 61.

Therefore, one or both of the controller 61 and the computer 62 may be regarded as “control apparatus”.

Note that the insertion work is explained in the embodiment, however, the work is not limited to, but includes a pull-out work. In a case of the pull-out work, from the second information on the insertion direction input to the second input portion 42, an opposite direction to the insertion direction may be used as a pull-out direction, or second information on the pull-out direction may be input by the second input portion 42. The pull-out direction refers to a movement direction of the workpiece W1 when the workpiece W1 is pulled out from the workpiece W2. Further, a pull-out length may be obtained from the third information on the insertion length input to the third input portion 43, or third information on a distance of pull-out when the workpiece W1 is pulled out of the insertion hole of the workpiece W2 may be input.

Furthermore, in the case of the pull-out work, the table T is stored with respect to each type of the workpiece W1 or the workpiece W2 and pull-out direction. A takt time and a parameter set in the pull-out work may be obtained with reference to the table T.

### Modified Example 1

FIG. 9 is a block diagram showing modified example 1 of the robot system with a focus on hardware.

FIG. 9 shows an overall configuration of a robot system 100B in which a computer 63 is directly coupled to the robot 1. The control of the robot 1 is directly executed by reading of a command in a memory using a processor in the computer 63.

Therefore, the computer 63 may be regarded as “control apparatus”.

### Modified Example 2

FIG. 10 is a block diagram showing modified example 2 of the robot system with a focus on hardware.

FIG. 10 shows an overall configuration of a robot system 100C in which the robot 1 containing the controller and a computer 66 are coupled and the computer 66 is coupled to a cloud 64 via a network 65 such as a LAN. The control of the robot 1 may be executed by reading of a command in a memory using a processor in the computer 66, or executed by reading of a command in a memory via the computer 66 using a processor on the cloud 64.

Therefore, one, two, or three of the controller 61, the computer 66, and the cloud 64 may be regarded as “control apparatus”.

As above, the method of presenting the takt time, the method of setting the force control parameter, the robot system, and the takt time presentation program according to the present disclosure are explained with respect to the illustrated embodiments, however, the present disclosure is not limited to the embodiments. The respective parts forming the robot system may be replaced by arbitrary configurations that may exert the same functions. Further, an arbitrary configuration may be added thereto.

What is claimed is:

1. A method of presenting a takt time in a robot having a robot arm driven by force control of presenting a takt time when the robot arm performs work to grip and insert or pull a first object into or out of a second object, comprising:
a first step of acquiring first information on a type of the first object or the second object and second information on a movement direction of the first object during the work; a second step of acquiring third information on a takt time taken for the work by using a table prepared with respect to each combination of the first information and the second information and showing relationships between a force control parameter and a takt time corresponding to the force control parameter, and associating the first information and the second information acquired at the first step with the table; and
a third step of presenting the third information acquired at the second step.

2. The method of presenting the takt time according to claim 1, wherein
at the second step, for one combination of the first information and the second information, a plurality of pieces of the third information corresponding to a plurality of the different force control parameters are acquired, and at the third step, the plurality of pieces of third information are presented.

3. The method of presenting the takt time according to claim 1, wherein
at the third step, an upper limit of an external force applied to the robot arm during the work is presented according to the first information and the second information input at the first step.

4. The method of presenting the takt time according to claim 1, wherein
at the first step, at least one piece of information of an insertion distance of the first object, a movement distance of the first object from a work start position to a contact position in which the first object and the second object contact, and whether or not an attitude of the first object is changed during the work is further acquired.

5. A method of setting a force control parameter in a robot having a robot arm driven by force control of setting a force control parameter by presenting a takt time when the robot arm performs work to grip and insert or pull a first object into or out of a second object, comprising:
a first step of acquiring first information on a type of the first object or the second object and second information on a movement direction of the first object during the work; a second step of acquiring third information on a takt time taken for the work by using a table prepared with respect to each combination of the first information and the second information and showing relationships between a force control parameter and a takt time corresponding to the force control parameter, and associating the first information and the second information acquired at the first step with the table;
a third step of presenting the third information acquired at the second step; and
a fourth step of setting the force control parameter corresponding to the third information as a work force control parameters during the work.

6. The method of setting the force control parameter according to claim 5, wherein
at the fourth step, the force control parameter corresponding to the selected third information is set as a work force control parameter during the work.

7. A robot system comprising:
a robot having a robot arm that performs work to grip and insert or pull a first object into or out of a second object by force control;
a presentation unit; and
a control unit that controls actuation of the presentation unit, wherein
of the first object or the second object and second information on a movement direction of the first object during the work, acquires third information on a takt time taken for the work by using a table prepared with respect to each combination of the first information and the second information and showing relationships between a force control parameter and a takt time corresponding to the force control parameter, and associating the acquired first information and second information with the table, and controls the actuation of the presentation unit to present the acquired third information.

8. A non-transitory computer-readable storage medium storing a takt time presentation program for presenting, in a robot having a robot arm driven by force control, a takt time when the robot arm performs work to grip and insert or pull a first object into or out of a second object, for executing:
a first step of acquiring first information on a type of the first object or the second object and second information on a movement direction of the first object during the work;
a second step of acquiring third information on a takt time taken for the work by using a table prepared with respect to each combination of the first information and the second information and showing relationships between a force control parameter and a takt time corresponding to the force control parameter, and associating the first information and the second information acquired at the first step with the table; and
a third step of presenting the third information acquired at the second step.
